(19) United States
(12) Patent Application Publication
(10) Pub. No.: US 2025/0304837 A1
(43) Pub. Date: Oct. 2, 2025

(54) Formaldehyde Free Fabric Coating

(71) Applicant: Fenner Dunlop Americas, LLC, Coraopolis, PA (US)

(72) Inventors: Morgan Michele Jones, Hartwell, GA (US); Alan Michael Levesley, Anderson, SC (US)

(21) Appl. No.: 19/095,922

(22) Filed: Mar. 31, 2025

Related U.S. Application Data
(60) Provisional application No. 63/572,314, filed on Mar. 31, 2024.

(51) Int. Cl. C09J 109/06; B32B 5/02; B32B 5/22; B32B 7/12; B32B 25/04; B32B 25/18; B32B 37/12; C09J 5/00; D06M 15/233

(52) U.S. Cl. CPC C09J 109/06; B32B 5/024; B32B 5/22; B32B 7/12; B32B 25/04; B32B 25/18; B32B 37/1207; C09J 5/00; D06M 15/233; B32B 2037/123; B32B 2262/0276; B32B 2305/72; B32B 2319/00

(57) ABSTRACT

An adhesive composition and method of making the adhesive composition. The adhesive composition is a formaldehyde-free and aqueous composition includes at least a styrene butadiene latex, a blocked isocyanate, and a styrene butadiene vinylpyridine terpolymer. The adhesive composition can be utilized in a method for coating textiles for subsequent bonding to rubber.

### CROSS REFERENCE TO RELATED PATENT APPLICATIONS

This patent application claims the benefit of and priority to U.S. Provisional Patent Application Ser. No. 63/572,314 filed on Mar. 31, 2024, the entire contents of which are incorporated herein by reference for all purposes.

### FIELD

The present invention is directed to coatings and methods of bonding fabric. More specifically, the present invention relates to formaldehyde-free adhesives for bonding rubber to fabric.

### BACKGROUND OF THE INVENTION

The current state of the art for bonding rubber to fabric is RFL (Resorcinol-Formaldehyde-Latex). However, the hazards of (RF) Resorcinol-Formaldehyde are becoming ever more clear. Thus, there is a need for a new adhesive treatment for fabrics such as nylon, polyester, and aramid fabrics.

### SUMMARY

Accordingly, there is a need for a formaldehyde-free adhesive coating. The compositions, methods, and articles described herein overcome the above-mentioned environmental and health issues while maintaining desirable adhesion properties.

In a first aspect, an adhesive composition for coating textiles is disclosed, the composition comprising: (a) a styrene butadiene latex from 4.57 wt % to 40.38 wt %, preferably from 7.31 wt % to 29.75 wt %, more preferably 9.97 wt % to 17.19 wt %; based on the total weight of the composition, (b) a blocked isocyanate from 1.46 wt % to 18.20 wt %, preferably from 2.88 wt % to 15.11 wt %, more preferably 4.26 wt % to 8.17 wt %; based on the total weight of the composition; (c) a styrene butadiene vinylpyridine terpolymer from 13.81 wt % to 54.83 wt %, preferably from 21.95 wt % to 46.63 wt %, more preferably 26.36 wt % to 38.32 wt %; based on the total weight of the composition; and (d) water from 29.03 wt % to 52.64 wt %, preferably from 33.97 wt % to 48.03 wt %, more preferably 38.26 wt % to 45.37 wt %; based on the total weight of the composition; wherein the styrene butadiene latex and the blocked isocyanate are present at a ratio from 1.5:1 to 2.8:1.

In certain aspects, the composition further comprises a thickener selected from the group consisting of: an acrylic thickener, guar gum, paraffin wax. In certain aspects, the thickener may be present from 0.42 wt % to 1.82 wt %, preferably from 0.57 wt % to 1.68 wt %, more preferably 0.85 wt % to 1.40 wt %, based on the total weight of the composition.

In certain aspects, the composition further comprises a surfactant from 0.03 wt % to 0.20 wt %, preferably from 0.06 wt % to 0.17 wt %, more preferably 0.08 wt % to 0.14 wt %, based on the total weight of the composition. In certain aspects, the surfactant may be sodium dioctyl sulfosuccinate, ammonium lauryl sulfate, sodium pareth sulfate.

In certain aspects, the composition further comprises a defoamer selected from the group consisting of: amide wax, sulfonated oil, organic phosphates, silicone oils, mineral oils, polysiloxanes, and combinations thereof. In certain aspects, the defoamer is present in the composition from 0.01 wt % to 0.10 wt %, preferably from 0.03 wt % to 0.08 wt %, more preferably 0.04 wt % to 0.07 wt %, based on the total weight of the composition.

In certain aspects, the composition further comprises an adhesion promotor selected from the group consisting of: a caprolactam-blocked methylene diisocyanate, methylenebis phenyl isocyanate, methylene bis-cyclohexylisocyanate, hexamethylene diisocyanate. In certain aspects, the adhesion promotor is present in the composition from 2.17 wt % to 12.89 wt %, preferably from 3.57 wt % to 10.58 wt %, more preferably 4.25 wt % to 8.15 wt %, based on the total weight of the composition.

In certain aspects, the composition comprises 20%-30% solids.

In certain aspects, the composition has an alkaline pH. In certain aspects, the alkaline pH is from 8.0 to 10, preferably from 8.5 to 9.5, more preferably from 9.25 to 9.4.

In certain aspects, the composition has a viscosity of 20 to 500 at room temperature, preferably from 30 to 300, more preferably from 30 to 100.

In another aspect, a method of preparing an adhesive composition is disclosed, the method comprising: (a) preparing a first aqueous mixture comprising a first styrene butadiene latex, a blocked isocyanate, a first styrene butadiene vinylpyridine terpolymer; and (b) adding, after a predetermined period of time, to the first aqueous mixture, a second aqueous mixture comprising a second styrene butadiene vinylpyridine terpolymer and a second styrene butadiene latex.

In certain aspects, the first aqueous mixture comprises the styrene butadiene latex at a concentration from 3.31 wt % to 28.85 wt %, preferably from 5.22 wt % to 21.25 wt %, and more preferably from 7.12 wt % to 12.23 wt %, based on the total weight of the first aqueous mixture.

In certain aspects, the first aqueous mixture comprises the blocked isocyanate at a concentration from 1.46 wt % to 18.20 wt %, preferably from 2.88 wt % to 15.11 wt %, and more preferably from 4.26 wt % to 8.17 wt %, based on the total weight of the first aqueous mixture.

In certain aspects, the first aqueous mixture comprises the styrene butadiene vinylpyridine terpolymer at a concentration of 9.86 wt % to 39.16 wt % preferably from 15.68 wt % to 33.31 wt %, and more preferably from 18.83 wt % to 27.37 wt %, based on the total weight of the first aqueous mixture.

In certain aspects, the second aqueous mixture comprises the second styrene butadiene vinylpyridine terpolymer at a concentration of 3.95 wt % to 15.67 wt % preferably from 6.27 wt % to 13.32 wt %, and more preferably from 7.53 wt % to 10.95 wt %, based on the total weight of the first aqueous mixture.

In certain aspects, the second aqueous mixture comprises the second styrene butadiene latex at a concentration of 1.32 wt % to 11.54 wt %, preferably from 2.09 wt % to 8.5 wt %, and more preferably from 2.85 wt % to 4.89 wt %, based on the total weight of the first aqueous mixture.

In another aspect, a method of coating textiles is disclosed, the method comprising: (a) providing an adhesive composition comprising: i. a styrene butadiene latex from 4.57 wt % to 40.38 wt %, based on the total weight of the composition; ii. a blocked isocyanate from 1.46 wt % to 18.20 wt %, based on the total weight of the composition; iii. a styrene butadiene vinylpyridine terpolymer from 13.81 wt % to 54.83 wt %, based on the total weight of the composition; and iv. water from 29.03 wt % to 52.64 wt %, based on the total weight of the composition; wherein the styrene butadiene latex and the blocked isocyanate are present at a ratio from 1.5:1 to 2.8:1; (b) submerging a textile material in the adhesive composition to form an adhesive-dipped textile; (c) drying the adhesive-dipped textile at a temperature from 225° F. to 350° F.; and (d) heat-setting the dried adhesive-dipped textile at a temperature from 375° F. to 500° F. to form an adhesive-coated textile.

In certain aspects, the method further comprises: (e) layering a sheet of rubber onto a first side of the adhesive-coated textile, and (f) vulcanizing the sheet of rubber forming.

In certain aspects, the method further comprises: (g) layering a first sheet of rubber onto a first side of the adhesive-coated textile, and a second sheet of rubber onto the second side of the adhesive-coated textile; and (h) vulcanizing the first sheet of rubber and the second sheet of rubber.

In another aspect, an article is disclosed, the article comprising: (a) a first adhesive-coated textile layer having a first side and a second side, wherein the first adhesive-coated textile layer is coated with an adhesive comprising: i. a styrene butadiene latex from 4.57 wt % to 40.38 wt %, based on the total weight of the composition; ii. a blocked isocyanate from 1.46 wt % to 18.20 wt %, based on the total weight of the composition; and iii. a styrene butadiene vinylpyridine terpolymer from 13.81 wt % to 54.83 wt %, based on the total weight of the composition.

In certain aspects, the article further comprises: (b) a first rubber layer adjacent the first side of the first adhesive-coated textile layer.

In certain aspects, the article further comprises: (c) a second rubber layer adjacent the second side of the first adhesive-coated textile layer.

In certain aspects, the article further comprises: (d) a second adhesive-coated textile layer having a first side and a second side; wherein the first side of the second adhesive-coated textile layer is adjacent the second rubber layer, and the second adhesive-coated textile material is coated with and adhesive comprising: i. a styrene butadiene latex from 4.57 wt % to 40.38 wt %, based on the total weight of the composition; ii. a blocked isocyanate from 1.46 wt % to 18.20 wt %, based on the total weight of the composition; and iii. a styrene butadiene vinylpyridine terpolymer from 13.81 wt % to 54.83 wt %, based on the total weight of the composition.

In certain aspects, the article further comprises: (e) a third rubber layer adjacent the second side of the adhesive-coated textile layer.

Embodiments of the invention can include one or more or any combination of the above features and configurations. Additional features, aspects and advantages of the invention will be set forth in the detailed description which follows, and in part will be readily apparent to those skilled in the art from that description or recognized by practicing the invention as described herein. It is to be understood that both the foregoing general description and the following detailed description present various embodiments of the invention, and are intended to provide an overview or framework for understanding the nature and character of the invention as it is claimed. The accompanying drawings are included to provide a further understanding of the invention, and are incorporated in and constitute a part of this specification.

### BRIEF DESCRIPTION OF THE DRAWINGS

The drawings described herein are for illustrative purposes for selected embodiments and

not all possible implementations, and are not intended to limit the scope of the present disclosure.

FIG. 1 is a flow-chart illustrating a method of coating textiles in accordance with embodiments of the present invention.

FIG. 2A illustrates a single-ply article in accordance with at least one embodiment of the present invention.

FIG. 2B illustrates a single-ply article in accordance with at least one embodiment of the present invention.

FIG. 2C illustrates a two-ply article in accordance with at least one embodiment of the present invention.

FIG. 2D illustrates a two-ply article in accordance with at least one embodiment of the present invention.

FIG. 3A illustrates a two-ply article in accordance with at least one embodiment of the present invention.

FIG. 3B illustrates a two-ply article in accordance with at least one embodiment of the present invention.

### DETAILED DESCRIPTION OF EMBODIMENTS OF THE INVENTION

The present invention will now be described more fully hereinafter with reference to the accompanying drawings in which exemplary embodiments of the invention are shown. However, the invention may be embodied in many different forms and should not be construed as limited to the representative embodiments set forth herein. The exemplary embodiments are provided so that this disclosure will be both thorough and complete, and will fully convey the scope of the invention and enable one of ordinary skill in the art to make, use and practice the invention.

It must be noted that, as used in the specification and the appended claims, the singular forms “a,” “an” and “the” include plural referents unless the context clearly dictates otherwise.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within the ranges as if each numerical value and sub-range is explicitly recited. As an illustration, a numerical range of “about 1 to 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc. as well as 1, 2, 3, 4, and 5, individually. The same principle applies to ranges reciting only one numerical value as a minimum or a maximum. Furthermore, such an interpretation should apply regardless of the breadth of the range or the characteristics being described.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

As used herein, the terms “fabric” and “textile” are used interchangeably and refer to a woven material comprising polyester, nylon, aramid, or combinations thereof.

As used herein, the term “rubber” refers to any materials comprising one or more of: Natural Rubber, Styrene Butadiene Rubber, Polybutadiene Rubber, Ethylene propylene diene monomer Rubber, Ethylene Propylene Rubber, Neoprene Rubber, Polychloroprene Rubber, and Nitrile Rubber.

It has surprisingly been found that blocked-isocyanate based adhesive dips can be used as a successful alternative to resorcinol-formaldehyde (“RF”) in resorcinol-formaldehyde latex (“RFL”) for bonding rubber to textile.

An important application of rubber bonded fabric is in conveyer belts and systems. Conveyer belts operate in very severe conditions, thus a high level of adhesion is required between the textile and the rubber component to increase the longevity of the conveyer belt.

The adhesive composition is prepared in two separate mixtures. The first mixture, comprising a first styrene butadiene latex, a blocked isocyanate, and a first styrene butadiene vinylpyridine terpolymer, is mixed. The second stage comprising a second styrene butadiene vinylpyridine terpolymer and a second styrene butadiene latex. The first mixture may further comprise a surfactant, a defoamer, an adhesion promotor. The second stage mixture may further comprise a thickener. In certain aspects, there is an optional aging step, wherein after a pre-determined period of time, from 1 minute to 168 hours, the second mixture is added to the first mixture.

The final mixture, once the first mixture and the second mixture are combined will have a viscosity, at room temperature, between 20 and 500 mPa-s, preferably between 30 and 300 mPa-s, and more preferably between 30 and 100 mPa-s. Additionally, the final mixture will have a pH from 8.0 to 10, preferably from 8.5 to 9.5, more preferably from 9.25 to 9.4. The basic pH is preferred to achieve optimal rubber adhesion to the coated textile.

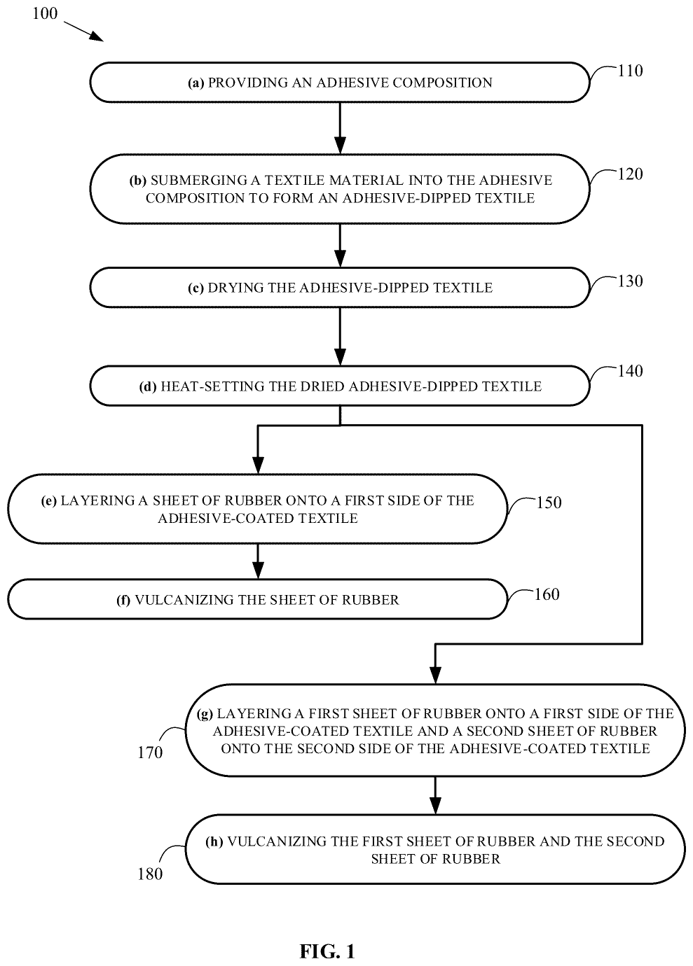

A method of coating textiles is shown in FIG. 1. Step (a) includes providing the adhesive composition described above (110). In some embodiments, providing the adhesive composition includes preparing the adhesive composition as described above. In some embodiments, providing the adhesive composition includes obtaining the prepared adhesive composition. Step (b) includes submerging a textile material into the adhesive composition to form an adhesive-dipped textile (120). In some embodiments, submerging may include dipping the textile into a container of adhesive composition. In some embodiments, submerging may include running the textile through a stream of adhesive composition. In some embodiments, the textile may be nylon, polyester, aramid, or blends thereof. Step (c) includes drying the adhesive-dipped textile (130). In some embodiments, the adhesive-dipped textile is dried at a temperature ranging from 225° F. to 350° F., preferably from 250° F. to 325° F., and more preferably from 260° F. to 315° F. Drying may include drying in multiple drying ovens and different temperatures. Step (d) includes heat-setting the dried adhesive-dipped textile to form the adhesive-coated textile (140). In some embodiments, heat-setting may include heating at temperatures from 375° F. to 500° F., preferably from 390° F. to 450° F., more preferably from 400° F. to 425° F. In some embodiments, drying and heat-setting occurs in a series of ovens, wherein the adhesive-dipped textile is run through the series of ovens at a line speed from 23-85 feet/minute, and wherein the first drying oven is at a temperature from 270° F. to 315° F., the second drying oven is at a temperature from 260° F. to 305° F., and the heat-setting oven is at a temperature from 400° F. to 425° F.

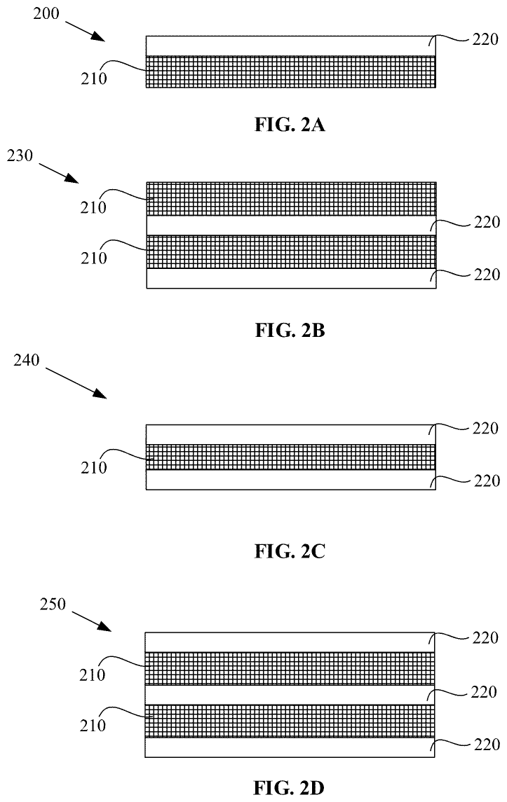

Once the adhesive-coated textile is prepared, the adhesive-coated textile can be layered with rubber to form various articles, such as conveyer belts or rubber coated textiles. Step (e) includes layering a sheet of rubber onto a first side of the adhesive-coated textile (150). Step (f) includes vulcanizing the sheet of rubber (160), forming a single-sided rubber-coated textile. In some embodiments, forming a single-sided rubber-coated textile includes layering an additional adhesive-coated textile and an additional layer of rubber prior to vulcanizing the rubber. A first single-sided rubber-coated textile (200) is shown in FIG. 2A. The first single-sided rubber-coated textile (200) includes an adhesive-coated textile layer (210) and a rubber layer (220). A second single-sided rubber coated textile (230) is shown in FIG. 2B. The second single-sided rubber-coated textile (230) includes two adhesive coated textile layers (210) and two rubber layers (220).

Alternatively, step (g) includes layering a first sheet of rubber onto a first side of the adhesive-coated textile and a second sheet of rubber onto the second side of the adhesive-coated textile (170). Step (h) includes vulcanizing the first and second sheets of rubber (180), forming a dual-sided rubber-coated textile. In some embodiments, forming a dual-sided rubber-coated textile includes layering an additional adhesive-coated textile and an additional layer of rubber prior to vulcanizing the rubber. A first double-sided rubber-coated textile (240) is shown in FIG. 2C. The first double-sided rubber-coated textile (240) includes an adhesive-coated textile layer (210) and two rubber layers (220). A second double-sided rubber coated textile (250) is shown in FIG. 2D. The second double-sided rubber-coated textile (250) includes two adhesive-coated textile layers (210) and three rubber layers (220).

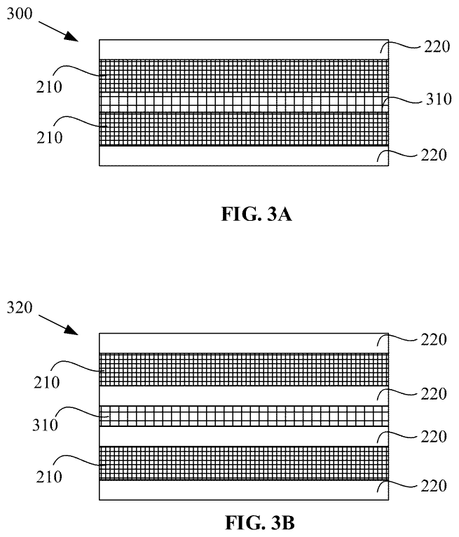

The rubber-coated textile may further comprise a steel cord. FIG. 3A illustrates a first steel cord double-sided rubber-coated textile (300), wherein a steel cord layer (310) is intermediate two adhesive-coated textile layers (210) and two rubber layers (220). FIG. 3B illustrates a second steel cord double-sided rubber-coated textile (320), wherein a steel cord layer (310) is intermediate two rubber layers (220) which is intermediate two adhesive-coated textile layers (210).

Additional layers are contemplated and are a part of the present disclosure. For example, the articles described herein may be one-ply, two-ply, three-ply, four-ply, five-ply, six-ply, seven-ply, and so on. Each ply consists of at least one adhesive-coated textile layer and one rubber layer. Each ply may further comprise a steel cord layer.

### WORKING EXAMPLES

An adhesive composition having comparable properties to traditional RFL dip was desired.

The preferred viscosity is from 20-175. The preferred pH is from 8.9-9.7. The percentage of solids is from 23.0%-25.0%. The preferred adhesion is 43/43-70.

### Example 1: Formaldehyde-Free Adhesive Composition

A formaldehyde-free adhesive composition was prepared by preparing a first mixture by combining styrene butadiene vinylpyridine terpolymer, with styrene butadiene latex, blocked isocyanate, an anionic surfactant, a thickener, and adhesion promotor, and water as shown below. After 18 hours, the second mixture was added, the second mixture consisting of styrene butadiene vinylpyridine terpolymer, styrene butadiene latex, a thickener, and water. The formulation for each of the first mixture and the second mixture are shown in Table 1.

TABLE 1

| | | | | | Wet, | Percen- |
|---|---|---|---|---|---|---|
| | Component | CAS No. | Parts | Grams | lbs | tage |
| First | Styrene | 100-42-5 | 182.93 | 239.13 | 3165 | 25.71 |
| Mixture | Butadiene | | | | | |
| | Vinylpyridine | | | | | |
| | Terpolymer | | | | | |
| | Carboxylated | 25085-39-6 | 60.98 | 79.71 | 1055 | 8.57 |
| | Styrene | | | | | |
| | Butadiene | | | | | |
| | Latex | | | | | |
| | Blocked | 54112-23-1 | 37.57 | 49.11 | 650 | 5.28 |
| | Isocyanate | | | | | |
| | Anionic | A345-500 | 0.80 | 1.05 | 14 | 0.11 |
| | surfactant | | | | | |
| | Thickener | 70563-43-8 | 2.40 | 3.14 | 42 | 0.34 |
| | Adhesion | 24969-11-7 | 35.75 | 46.73 | 618 | 5.03 |
| | Promotor | | | | | |
| | Deionized | — | 266.7 | 348.64 | 4614 | 37.48 |
| | Water | | | | | |
| Second | Styrene | 100-42-5 | 73.17 | 95.65 | 1266 | 10.29 |
| Mixture | Butadiene | | | | | |
| | Vinylpyridine | | | | | |
| | Terpolymer | | | | | |
| | Carboxylated | 25085-39-6 | 24.39 | 31.88 | 422 | 3.43 |
| | Styrene | | | | | |
| | Butadiene | | | | | |
| | Latex | | | | | |
| | Thickener | 8042-47-5 | 8.74 | 11.43 | 151 | 1.23 |
| | Deionized | — | 18 | 23.53 | 311 | 2.53 |
| | Water | | | | | |

### Example 2: Comparative Examples

The properties of comparative samples were evaluated. Comparative examples include: Resorcinol-Formaldehyde Latex (RFL) Dip, Adhesive No. 1, and Adhesive No. 2. Adhesive No. 1 and Adhesive No. 2 each comprise a Blocked Isocyanate (NG3-IL6) and Styrene Butadiene Vinylpyridine Terpolymer (adhesive prepared using 37.57 parts Grilbond IL-6 NG3 to 341.46 parts Styrene Butadiene Vinylpyridine Terpolymer). All mixes were aged for approximately 18 hours, wax and additional latex was added after an optional 18-hour aging period for each sample. The properties of each dip are shown below in Table 2.

TABLE 2

| | | | | Dip Pick-up |
|---|---|---|---|---|
| | Viscosity (cPa) | % Solids | pH | (avg) |
| RFL Dip | 17.5 | 24.3 | 9.38 | 11.9% |
| Adhesive No 1 | 16.75 | 23.0 | 11.82 | 10.0% |
| Adhesive No 2 | 16.75 | 23.6 | 11.35 | 10.7% |

The adhesive properties for the four samples above were also evaluated utilizing ASTM D416: Standard Test Method for Rubber Property-Adhesion to Flexible Substrate after two-ply samples with poly nylon fabric and three different types of rubber were prepared. Adhesion is measured between both covers and between plies. Adhesion is measured immediately after preparing the sample (initial results) and after 24 hours. The results are reported as follows: cover 1-cover 2/between ply 1-between ply 2. The results are shown in Table 3. The exponent on the value represent a measure of how much rubber was remaining on the fabric after the adhesion test is performed (1 being no rubber at all, and 5 being completely covered).

TABLE 3

| | Initial Results (lb/f) | Results after 24 hours |
|---|---|---|
| | Rubber 1 (SBR-Based Rubber) | |
| RFL Dip | 52² − 44²/100² − 81² | 50² − 45²/121³ − 94² |
| Adhesive No 1 | 45² − 52²/130² − 111² | 43² − 51²/112² − 123² |
| Adhesive No 2 | 58² − 48²/104² − 121² | 53² − 44²/95² − 103² |
| | Rubber 2 (SBR-Based Rubber) | |
| RFL Dip | 51² − 44²/93² − 84² | 54² − 48²/102² − 84² |
| Adhesive No 1 | 62² − 65²/127² − 129² | 85² − 55²/118² − 110² |
| Adhesive No 2 | 75² − 54²/180² − 155² | 68² − 53²/162² − 126² |
| | Rubber 3 (EPDM-Based Rubber) | |
| RFL Dip | 39² − 38²/81² − 75² | 37² − 36²/64² − 60² |
| Adhesive No 1 | 39² − 40²/70² − 58² | 36² − 33²/62² − 50² |
| Adhesive No 2 | 40² − 37²/67² − 63² | 36² − 33²/59² − 51² |

The present invention is directed to coatings and methods of bonding fabric. More specifically, the present invention relates to formaldehyde-free adhesives for bonding rubber to fabric.

### Example 3

A combination of Styrene Butadiene Vinylpyridine Terpolymer (VP) and a Styrene Butadiene Latex (SBR) were evaluated in the adhesive composition. The properties and adhesion results for a two-ply nylon textile are shown in Table 4.

TABLE 4

| | Viscosity | % | | Rubber | Initial | 72 Hour |
|---|---|---|---|---|---|---|
| | (cPa) | Solids | pH | Type | Adhesion | Adhesion |
| RFL Dip | 15.0 | 24.3% | 9.52 | Rubber 1 | 46²-49²/ | 45²-53²/ |
| | | | | | 67²-76² | 61²-76² |
| | | | | Rubber 2 | 47²-54²/ | 45²-48²/ |
| | | | | | 91²-84² | 96²-89² |
| | | | | Rubber 3 | 44²-43²/ | 40²-38²/ |
| | | | | | 91²-84² | 65²-50² |
| 75% VP/ | 12.5 | 23.4% | 11.01 | Rubber 1 | 65²-62²/ | 65²-67²/ |
| 25% SBR | | | | | 144²-143² | 135²-133² |
| | | | | Rubber 2 | 62²-72²/ | 65²-68²/ |
| | | | | | 164²-164² | 143²-151² |
| | | | | Rubber 3 | 40²-39²/ | 37²-37²/ |
| | | | | | 64²-64² | 62²-57² |
| 66% VP/ | 12.5 | 25.5% | 11.56 | Rubber 1 | 56²-57²/ | 52²-54²/ |
| 33% SBR | | | | | 120²-122² | 120²-109² |
| | | | | Rubber 2 | 71²-67²/ | 63²-62²/ |
| | | | | | 131²-168² | 150²-138² |
| | | | | Rubber 3 | 42²-43²/ | 39²-40²/ |
| | | | | | 73²-63² | 68²-53² |

### Example 4

A combination of Blocked Isocyanate (NG3-IL6), Styrene Butadiene Vinylpyridine Terpolymer (VP), and a Styrene Butadiene Latex (SBR) were evaluated in the adhesive composition along with a composition having NG3-IL6 and SBR. The properties and adhesion results for a two-ply nylon textile are shown in Table 5.

TABLE 5

| | Viscosity | % | | | Initial | 72 Hour |
|---|---|---|---|---|---|---|
| | (cPa) | Solids | pH | Rubber Type | Adhesion | Adhesion |
| RFL Dip | 20.0 | 24.01% | 9.2 | Rubber 1 | 40²-48²/ | 41²-48²/ |
| | | | | | 59²-64² | 59²-61² |
| | | | | Rubber 2 | 60²-44²/ | 54²-45²/ |
| | | | | | 77²-100² | 74²-84² |
| | | | | Rubber 3 | 24¹-26¹/ | 25¹-25¹/ |
| | | | | | 30¹-35¹ | 28¹-30¹ |
| 25% | 17.5 | 23.71% | 11.13 | Rubber 1 | 29²-34²/ | 26²-33²/ |
| NG3-IL6/ | | | | | 66²-73² | 60²-69² |
| 75% VP/ | | | | Rubber 2 | 41²-41²/ | 33²-36²/ |
| 25% SBR | | | | | 82²-90² | 75²-74² |
| | | | | Rubber 3 | 31²-27¹/ | 26²-25²/ |
| | | | | | 41²-39² | 37²-34² |

### Example 5

A carboxylated latex (XSBR) was substituted for SBR latex. Additionally, the pH was lowered slightly to pH 9.5. The properties and adhesion results for R250PN (250 lb fabric with a polyester warp and a nylon weft and a 1×2 broken twill weave pattern) and BUSINNN (breaker fabric with nylon warp, weft, and binder, A-2 weave pattern) are shown in Table 6.

TABLE 6

| | Viscosity | | | | Adhesion | Adhesion |
|---|---|---|---|---|---|---|
| | (cPa) | % Solids | pH | Rubber Type | R250PN | BUS1NNN |
| RFL Dip | 17.5 | 23.8% | 9.29 | Rubber 1 | 43²-41²/ | 47²-52²/ |
| | | | | | 78²-92² | 77²-71² |
| | | | | Rubber 2 | 56²-56²/ | 51²-55²/ |
| | | | | | 117²-108² | 68²-81² |
| | | | | Rubber 3 | 40²-39²/ | 21¹-19¹/ |
| | | | | | 65²-64² | 21¹-25¹ |
| 25% | 62.5 | 25.05% | 9.5 | Rubber 1 | 48²-48²/ | 49²-58²/ |
| NG3-IL6/ | | | | | 92²-136² | 76²-67² |
| 75% VP/ | | | | Rubber 2 | 48²-54²/ | 52²-49²/ |
| 25% | | | | | 113²-124² | 114²-101² |
| XSBR | | | | Rubber 3 | 42²-39²/ | 30²-27¹/ |
| | | | | | 70²-54² | 45²-35² |

The foregoing description provides embodiments of the invention by way of example only. It is envisioned that other embodiments may perform similar functions and/or achieve similar results. Any and all such equivalent embodiments and examples are within the scope of the present invention and are intended to be covered by the appended claims.

1. An adhesive composition for coating textiles, the composition comprising:
(a) a styrene butadiene latex from 4.57 wt % to 40.38 wt %, based on the total weight of the composition;
(b) a blocked isocyanate from 1.46 wt % to 18.20 wt %, based on the total weight of the composition;
(c) a styrene butadiene vinylpyridine terpolymer from 13.81 wt % to 54.83 wt %, based on the total weight of the composition; and
(d) water from 29.03 wt % to 52.64 wt %, based on the total weight of the composition, wherein the styrene butadiene latex and the blocked isocyanate are present at a ratio from 1.5:1 to 2.8:1.

2. The composition according to claim 1, wherein the composition further comprises a thickener selected from the group consisting of: an acrylic thickener, guar gum, paraffin wax.

3. The composition according to claim 1, wherein the composition further comprises a defoamer selected from the group consisting of: amide wax, sulfonated oil, organic phosphates, silicone oils, mineral oils, polysiloxanes, and combinations thereof.

4. The composition according to claim 1, wherein the composition further comprises an adhesion promotor selected from the group consisting of: a caprolactam-blocked methylene diisocyanate, methylenebis phenyl isocyanate, methylene bis-cyclohexylisocyanate, hexamethylene diisocyanate.

5. The composition according to claim 1, wherein the composition further comprises a surfactant.

6. The composition according to claim 1, wherein the composition comprises from 20%-30% solids.

7. The composition according to claim 1, wherein the composition has an alkaline pH.

8. The composition according to claim 7, wherein the alkaline pH is from 7.5 to 9.5.

9. The composition according to claim 1, wherein the composition has a viscosity of 20 mPa-s to 500 mPa-s at room temperature.

10. A method of preparing an adhesive composition, the method comprising:
(a) preparing a first aqueous mixture comprising a first styrene butadiene latex, a blocked isocyanate, and a first styrene butadiene vinylpyridine terpolymer; and
(b) adding, after a predetermined period of time, to the first aqueous mixture, a second aqueous mixture comprising a second styrene butadiene vinylpyridine terpolymer and a second styrene butadiene latex.

11. The method according to claim 10, wherein the first aqueous mixture comprises the styrene butadiene latex at a concentration from 3.31 wt % to 28.85 wt %, based on a total weight of the first aqueous mixture.

12. The method according to claim 10, wherein the first aqueous mixture comprises the blocked isocyanate at a concentration from 1.46 wt % to 18.20 wt %, based on a total weight of the first aqueous mixture.

13. The method according to claim 10, wherein the first aqueous mixture comprises the styrene butadiene vinylpyridine terpolymer at a concentration of 9.86 wt % to 39.16 wt % based on a total weight of the first aqueous mixture.

14. The method according to claim 10, wherein the second aqueous mixture comprises the second styrene butadiene vinylpyridine terpolymer at a concentration of 3.95 wt % to 15.67 wt % based on a total weight of the second aqueous mixture.

15. The method according to claim 10, wherein the second aqueous mixture comprises the second styrene butadiene latex at a concentration of 1.32 wt % to 11.54 wt %, based on a total weight of the second aqueous mixture.

16. A method of coating textiles, the method comprising:
(a) providing an adhesive composition comprising:
i. a styrene butadiene latex from 4.57 wt % to 40.38 wt %, based on a total weight of the composition;
ii. a blocked isocyanate from 1.46 wt % to 18.20 wt %, based on the total weight of the composition;
iii. a styrene butadiene vinylpyridine terpolymer from 13.81 wt % to 54.83 wt %, based on the total weight of the composition; and
iv. water from 29.03 wt % to 52.64 wt %, based on the total weight of the composition, wherein the styrene butadiene latex and the blocked isocyanate are present at a ratio from 1.5:1 to 2.8:1;
(b) submerging a textile material in the adhesive composition to form an adhesive-dipped textile;
(c) drying the adhesive-dipped textile at a temperature from 225° F. to 350° F.; and
(d) heat-setting the dried adhesive-dipped textile at a temperature from 375° F. to 500° F. for form an adhesive-coated textile.

17. The method according to claim 16, further comprising:
(e) layering a first sheet of rubber onto a first side of the adhesive-coated textile, and
(f) vulcanizing the sheet of rubber.

18. The method according to claim 16, further comprising:
(g) layering a first sheet of rubber onto a first side of the adhesive-coated textile, and a second sheet of rubber onto the second side of the adhesive-coated textile; and
(h) vulcanizing the first sheet of rubber and the second sheet of rubber.

19. An article comprising:
(a) a first adhesive-coated textile layer having a first side and a second side, wherein the first adhesive-coated textile layer is coated with an adhesive comprising:
i. a styrene butadiene latex from 7.40 wt % to 53.58 wt %, based on a total weight of the composition;
ii. a blocked isocyanate from 3.74 wt % to 36.85 wt %, based on the total weight of the composition; and
iii. a styrene butadiene vinylpyridine terpolymer from 28.20 wt % to 74.85 wt %, based on the total weight of the composition.

20. The article according to claim 19, wherein the article further comprises:
(b) a first rubber layer adjacent the first side of the first adhesive-coated textile layer;

21. The article according to claim 20, wherein the article further comprises:
(c) a second rubber layer adjacent the second side of the first adhesive-coated layer.

22. The article according to claim 21, wherein the article further comprises:
(d) a second adhesive-coated textile layer having a first side and a second side, wherein the first side of the second adhesive-coated textile layer is adjacent the second rubber layer, and the second adhesive-coated textile layer is coated with the adhesive comprising:
i. the styrene butadiene latex from 7.40 wt % to 53.58 wt %, based on the total weight of the composition;
ii. the blocked isocyanate from 3.74 wt % to 36.85 wt %, based on the total weight of the composition; and
iii. the styrene butadiene vinylpyridine terpolymer from 28.20 wt % to 74.85 wt %, based on the total weight of the composition.

23. The article according to claim 22, wherein the article further comprises:
(e) a third rubber layer adjacent the second side of the adhesive-coated textile layer.
